(19) United States
(12) Patent Application Publication
(10) Pub. No.: US 2006/0161641 A1
(43) Pub. Date: Jul. 20, 2006

(54) Computer-readable recording medium, relay control method, and relay control apparatus

(75) Inventors: Atsuji Sekiguchi, Kawasaki (JP); Satoshi Tsuchiya, Kawasaki (JP); Eiki Iwata, Yasugi (JP); Kazuki Shimojima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/169,832

(22) Filed: Jun. 30, 2005

(30) Foreign Application Priority Data
Jan. 19, 2005 (JP) 2005-011920

(51) Int. Cl. G06F 15/16

(52) U.S. Cl. 709/219; 709/203

(57) ABSTRACT

A computer-readable medium storing a computer program for controlling relay of a client request from a client terminal to a server. The computer program includes instructions for causing a computer to execute determining a process corresponding to the client request, based on both an allowable waiting time for which the client terminal allows to wait for a response corresponding to the client request from the server and on a capacity of the server, and processing the client request, based on a result of the determination.

### BACKGROUND OF THE INVENTION

1) Field of the Invention

The present invention relates to a technology for controlling relaying of a client request transmitted to a server from a client terminal.

2) Description of the Related Art

Business using the Internet is growing recently. In client-server systems over the Internet, the distances between a server that provides services and users do not matter and the number of electronic devices to be connected to the Internet is rapidly increasing. Therefore, access requests from users are likely to flood into the server, and this easily overloads the server in providing services over the Internet, and this likely leads to reduction in service level and server down, thereby disabling provision of services.

As a solution to this problem, the capacity on demand (CoD) technology (or the utility operating technology) has been developed. The CoD technology changes the number of servers according to the amount of requests from clients. With the use of the CoD technology, even when servers are overwhelmed by access requests from the users, reduction in service level and service malfunctions caused by server down are prevented.

However, the CoD technology requires a predetermined time for a server extension, so that when excessive service requests that overwhelm the processing capacity come in within the predetermined time, the requests that cannot be coped with have to be canceled. As a result, retransmission requests are issued to thereby further overload the system or prolonging the response times to clients, lowering the service level.

Some methods for coping with the situation are to shorten the time for a server extension and predict such time. Those approaches however cannot cope with a change in the amount of requests within a time less than several seconds to several minutes that are needed for the server extension or an unexpected increase in the amount of requests.

Some conventional methods for overcoming the situation are to inform a client of a waiting time and instruct to retransmit a request (see for example, Japanese Patent Application Laid-open No. H2001-265693), and temporarily let a request stay on hold to cope with lowering of the service level and an increase in load caused by retransmissions (see for example, Japanese Patent Application No. 2004-056082).

However, the technology of informing a client of a waiting time and instructing to retransmit a request inevitably generates traffic and waiting time more than necessary, because a retransmission instruction is generated even when the waiting time is as short as several seconds.

The technology of temporary letting requests stay on hold makes the request remain staying on hold even when the waiting time is longer than the time-out on a user side, resulting in an unpleasant waiting time (no-response time).

In other words, because the conventional technologies do not consider the relationship between the time-out period on the user side and the waiting time, there occurs traffic and waiting time that are more than necessary.

### SUMMARY OF THE INVENTION

It is an object of the present invention to at least solve the problems in the conventional technology.

A computer-readable medium according to an aspect of the present invention stores a computer program for controlling relay of a client request from a client terminal to a server, the computer program including instructions for causing a computer to execute: determining a process corresponding to the client request, based on both an allowable waiting time for which the client terminal allows to wait for a response corresponding to the client request from the server and on a capacity of the server; and processing the client request, based on a result of the determination.

A relay control method according to another aspect of the present invention for controlling relay of a client request from a client terminal to a server, includes: determining a process corresponding to the client request, based on both an allowable waiting time for which the client terminal allows to wait for a response corresponding to the client request from the server and on a capacity of the server; and processing the client request, based on a result of the determination.

A relay control apparatus according to still another aspect of the present invention for controlling relay of a client request from a client terminal to a server includes: a process determining unit configured to determine a process corresponding to the client request, based on both an allowable waiting time for which the client terminal allows to wait for a response corresponding to the client request from the server and on a capacity of the server; and a request processing unit configured to process the client request, based on the determination made by the process determining unit.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a functional block diagram of the configuration of a relay control apparatus according to the first embodiment;

FIG. 2 is one example of an entry data structure of a request queue;

FIG. 3 is a flowchart of procedures of the relay control apparatus according to the first embodiment that are performed when receiving a new request;

FIG. 4 is a flowchart of procedures of a stay request process that is performed by the relay control apparatus according to the first embodiment;

FIG. 5 is a flowchart of procedures of a transfer process shown in FIG. 4;

FIG. 6 is a flowchart of procedures of a retransmission instruction process;

FIG. 7 is a functional block diagram of the configuration of a relay control apparatus according to a second embodiment;

FIG. 8 is a flowchart of procedures of the relay control apparatus according to the second embodiment that are performed when receiving a new request;

FIG. 9 is a flowchart of procedures of a stay request process that is performed by the relay control apparatus according to the second embodiment; and

FIG. 10 is a functional block diagram of the configuration of a computer that executes a relay control program according to the first and the second embodiments.

### DETAILED DESCRIPTION

Exemplary embodiments of a relay control program, a recording medium therefore, a relay control method, and a relay control apparatus according to the present invention will be explained below with reference to the accompanying drawings.

### First Embodiment

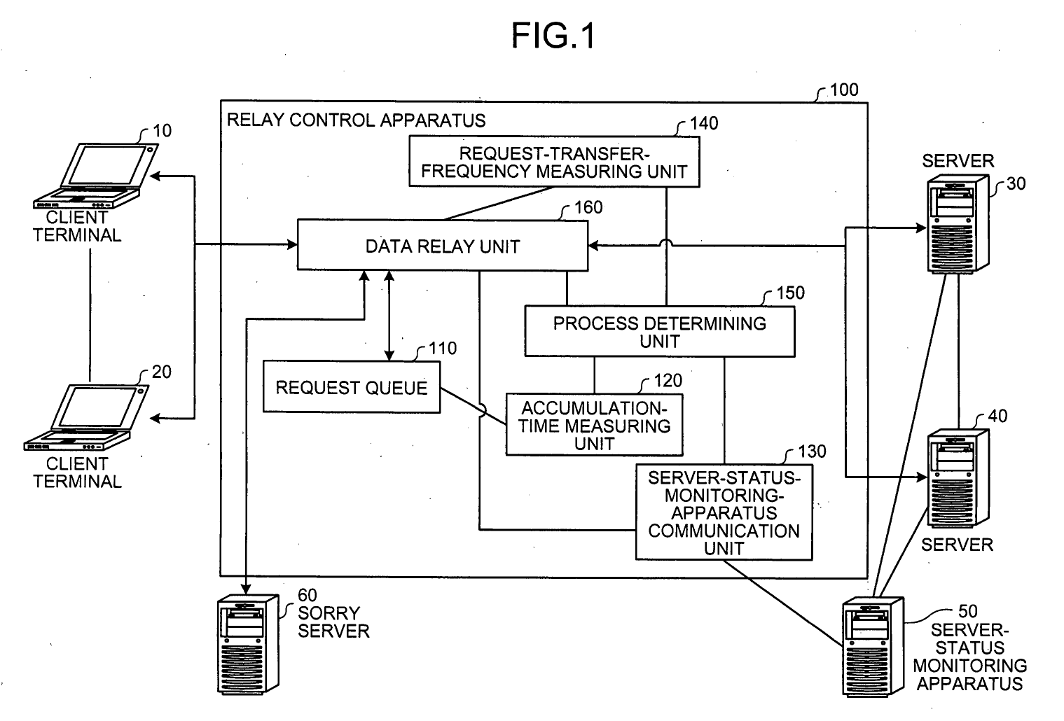

The configuration of a relay control apparatus according to a first embodiment will be described first. FIG. 1 is a functional block diagram of the configuration of a relay control apparatus 100 according to the first embodiment. As shown in FIG. 1, the relay control apparatus 100 receives a client request from a client terminal 10 or 20, transfers the client request to a server 30 or 40, receives a response to the client request from the server 30 or 40, and transfers the response to the client terminal 10 or 20.

While only two client terminals 10 and 20 and two servers 30 and 40 are shown for the sake of explanation, the relay control apparatus 100 can be connected to an arbitrary number of client terminals and servers.

The relay control apparatus 100 includes a request queue 110, an stay time measuring unit 120, a server-status-monitoring-apparatus (SSMA) communication unit 130, a request-transfer-frequency measuring unit 140, a process determining unit 150, and a data relay unit 160.

The request queue 110 stores a client request sent from the client terminal 10 or 20. The data relay unit 160 writes and read a client request.

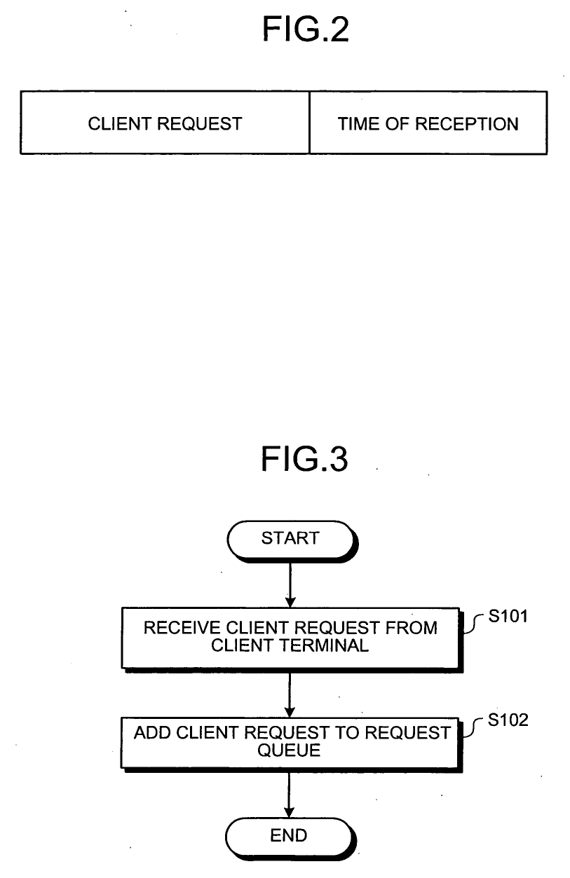

FIG. 2 is one example of the entry data structure of the request queue 110. As shown in FIG. 2, a client request and information on the time of reception of the client request are stored in the request queue 110.

The stay time measuring unit 120 measures a stay time of a client request stored at a head of the request queue 110, and sends the measured stay time to the process determining unit 150. The stay time is a time period for which the client request is staying on hold. Specifically, the stay time measuring unit 120 measures as the stay time a time period between a time the client request is received and a present time.

The SSMA communication unit 130 receives information on the capacity and statuses of the server 30 and 40 from a server-status monitoring apparatus 50 that monitors such server capacity and statuses, calculates a transfer frequency upper limit from the total capacity of the servers, and sends the transfer frequency upper limit to the process determining unit 150. The “transfer frequency upper limit” is a numerical upper limit of client requests that can be processed within a unit time by the servers 30 and 40.

The request-transfer-frequency measuring unit 140 measures a request transfer frequency at which a client request is transferred to the server 30 or 40 from the relay control apparatus 100, and sends the request transfer frequency to the process determining unit 150.

The process determining unit 150 determines a process for a client request stored at the head of the request queue 110. Specifically, the process determining unit 150 determines whether a client request is to be transferred to a server based on the request transfer frequency received from the request-transfer-frequency measuring unit 140.

When it is determined that the client request is to be transferred to a server, the process determining unit 150 instructs the data relay unit 160 to transfer the client request. When it is determined that the client request is not to be transferred to a server, the process determining unit 150 determines whether the client request is to stay on hold or a retransmission request is to be sent to an associated client terminal, based on whether the stay time received from the stay time measuring unit 120 lies within a predetermined maximum allowable stay time. The “maximum allowable stay time” is a maximum time for which a client request is allowed to stay on hold, and is calculated based on a time-out period or an allowable waiting time of a user.

As the process determining unit 150 determines whether to make the client request stay on hold or to send a retransmission request to the client terminal based on the stay time of the client request, it is possible to eliminate an unnecessary retransmission request and prevent occurrence of a situation where a user is given an unpleasant waiting time.

The data relay unit 160 receives a client request from the client terminal 10 or 20 and stores the client request in the request queue 110. When the process determining unit 150 determines that the client request is to be transferred to the associated server, the data relay unit 160 takes the client request from the head of the request queue 110, and transfers the client request to one of the servers 30 and 40, based on the load statuses of the servers. The data relay unit 160 receives a response to the client request from the server, and transfers the response to the client terminal 10 or 20.

When the process determining unit 150 determines that a retransmission instruction is given to the associated client terminal, the data relay unit 160 takes the client request from the head of the request queue 110, and sends the client request to a sorry server 60 that generates a retransmission instruction message. Upon reception of the retransmission instruction message from the sorry server 60, the data relay unit 160 sends the retransmission instruction message to the client terminal 10 or 20.

The following will explain procedures of the relay control apparatus 100 according to the first embodiment when receiving a new request. FIG. 3 is a flowchart of procedures of the relay control apparatus 100 according to the first embodiment that are performed when receiving a new request.

As shown in FIG. 3, the data relay unit 160 in the relay control apparatus 100 receives a client request from the client terminal 10 or 20 (step S101). The data relay unit 160 then adds the received client request to the request queue 110 (step S102).

As described above, the relay control apparatus 100 according to the first embodiment temporarily stores a client request from the client terminal 10 or 20, in the request queue 110.

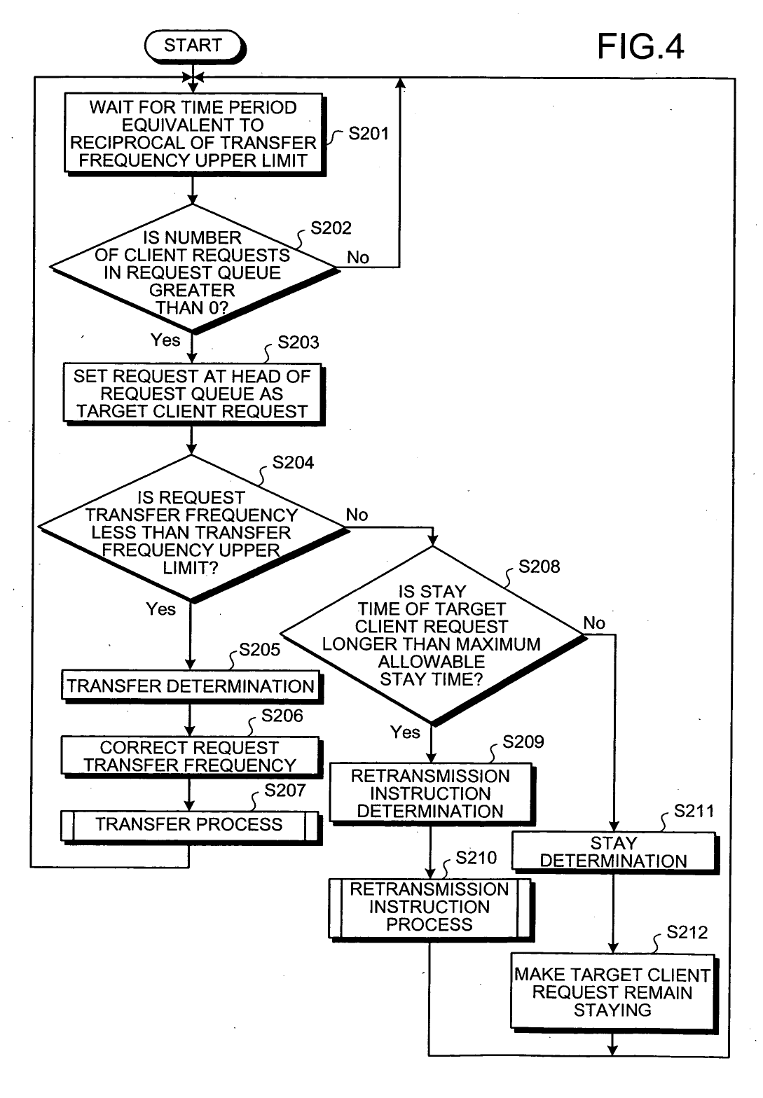

A stay request process carried out by the relay control apparatus 100 according to the first embodiment for processing a client request in the request queue 110 is now explained. FIG. 4 is a flowchart of procedures of the stay request process that is performed by the relay control apparatus 100 according to the first embodiment.

As shown in FIG. 4, in the stay request process, the process determining unit 150 waits for a time period that is the reciprocal of the transfer frequency upper limit received from the SSMA communication unit 130, namely, the most frequent transfer period (step S201), and determines whether there is a client request in the request queue 110 (step S202).

When there is no client request in the request queue 110, the process determining unit 150 waits again for the most frequent transfer period and determines again whether there is a client request in the request queue 110 (step S202). That is, the process determining unit 150 checks whether there is a client request in the request queue 110 every most frequent transfer period.

When there is a client request in the request queue 110, the process determining unit 150 sets the client request at the head of the request queue 110 as a client request, the processing of which is to be determined (step S203), then determines whether the request transfer frequency received from the request-transfer-frequency measuring unit 140 has reached the transfer frequency upper limit received from the SSMA communication unit 130 (step S204).

When the request transfer frequency received has not reached the transfer frequency upper limit, the process determining unit 150 determines that the client request should be transferred to the associated server (step S205), and instructs the request-transfer-frequency measuring unit 140 to correct the request transfer frequency (step S206).

The data relay unit 160 then performs a transfer process of transferring the client request to the server based on the transfer determination made by the process determining unit 150 (step S207), and returns to step S201 to repeat the stay request process.

When the request transfer frequency received has reached the transfer frequency upper limit, the process determining unit 150 receives the stay time of the target client request from the stay time measuring unit 120, and determines whether the stay time is longer than the maximum allowable stay time (step S208).

Accordingly, when the stay time is longer than the maximum allowable stay time, the process determining unit 150 performs a retransmission instruction determination to instruct the associated client terminal to retransmit the request (step S209), and the data relay unit 160 performs a retransmission instruction process to retransmit the request based on the retransmission instruction determination of the process determining unit 150 (step S210).

On the other hand, when the stay time is not longer than the maximum allowable stay time, the process determining unit 150 performs a stay determination to make the client request stay on hold (step S211), and makes the target client request remain staying on hold (step S212). The process determining unit 150 then returns to step S201 to repeat the stay request process.

As the process determining unit 150 determines a process for a client request stored at the head of the request queue 110 based on the request transfer frequency and the stay time of the client request, thus suppressing occurrence of a wasteful retransmission request and occurrence of an unpleasant waiting time.

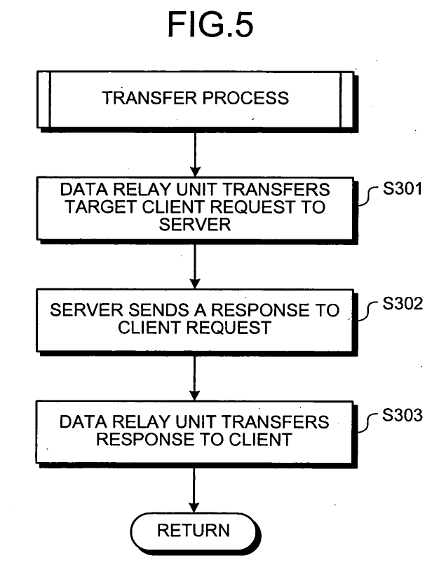

Procedures of the transfer process (step S207) shown in FIG. 4 will be described next. FIG. 5 is a flowchart of procedures of the transfer process shown in FIG. 4.

As shown in FIG. 5, in the transfer process, the data relay unit 160 takes the client request at the head of the request queue 110, and transfers the client request to the server 30 or 40 based on the transfer determination made by the process determining unit 150 (step S301).

The server 30 or 40 then sends a message as a response to the client request (step S302), and the data relay unit 160 having received the response sends it to the client terminal (step S303).

As the data relay unit 160 transfers the client request to the server 30 or 40 based on the transfer determination made by the process determining unit 150, the client request can be transferred to the server within the server's capacity.

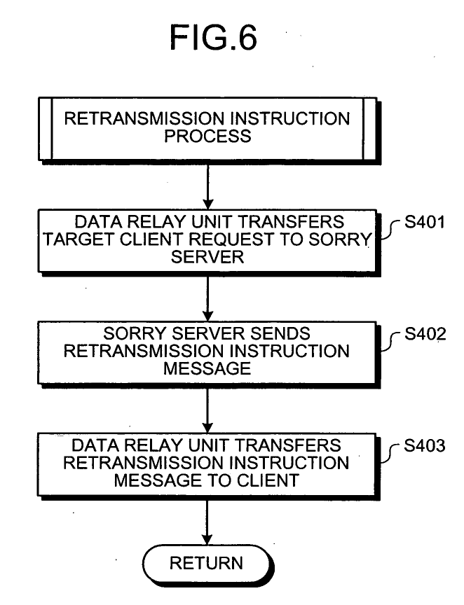

Procedures of the retransmission instruction process (step S210) shown in FIG. 4 will be described next. FIG. 6 is a flowchart of procedures of the retransmission instruction process.

As shown in FIG. 6, in the retransmission instruction process, the data relay unit 160 takes the client request at the head of the request queue 110, and transfers the client request to the sorry server 60 based on the retransmission instruction determination made by the process determining unit 150 (step S401).

The sorry server 60 then sends a retransmission instruction message as a reply to the client request (step S402), and the data relay unit 160 having received the reply sends it to the client terminal (step S403).

As the data relay unit 160 transfers the client request to the sorry server 60 based on the retransmission instruction determination made by the process determining unit 150 and transfers a retransmission instruction message, generated by the sorry server 60, to the client terminal, an adequate retransmission instruction can be executed.

As described above, according to the first embodiment, the data relay unit 160 temporarily stores a received client request in the request queue 110, the process determining unit 150 determines a process for the client request in the request queue 110 based on the transfer frequency upper limit calculated by the SSMA communication unit 130, the request transfer frequency measured by the request-transfer-frequency measuring unit 140, and the stay time measured by the stay time measuring unit 120, and the data relay unit 160 transfers the client request to the associated server and performs a retransmission instruction to the client terminal based on the determination made by the process determining unit 150. This makes it possible to suppress wasteful retransmission requests and suppress undesired occurrence of an unpleasant waiting time for a user.

### Second Embodiment

While the foregoing description of the first embodiment has been given of the case that the process determining unit 150 determines whether to give a retransmission instruction or make the client request stay on hold based on the stay time of the client request, a retransmission instruction can be given to the client terminal earlier by predicting the stay time. The following description of a second embodiment describes a relay control apparatus that determines whether to give a retransmission instruction or make the client request stay on hold based on prediction of the stay time of the client request.

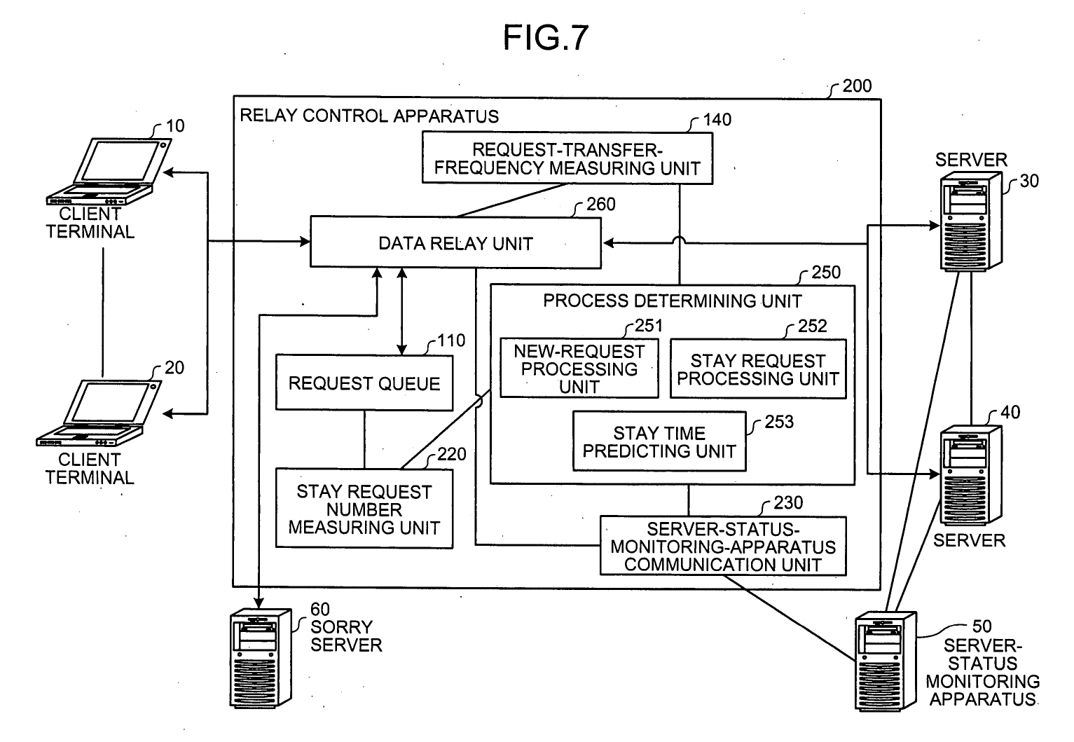

The configuration of the relay control apparatus according to the second embodiment will be described first. FIG. 7 is a functional block diagram of the configuration of a relay control apparatus 200 according to the second embodiment. For the sake of explanation, like reference signs are designated with like components that achieve functions similar to those of the corresponding components shown in FIG. 1, in order to avoid redundant descriptions.

As shown in FIG. 7, the relay control apparatus 200 includes a request queue 110, a stay request number measuring unit 220, an SSMA communication unit 230, a request-transfer-frequency measuring unit 140, a process determining unit 250, and a data relay unit 260.

The stay request number measuring unit 220 measures the number of client requests currently staying on hold in the request queue 110, and sends the measured number to the process determining unit 250.

The SSMA communication unit 230, like the SSMA communication unit 130, receives information on the capacity and statuses of the servers 30 and 40 from the server-status monitoring apparatus 50 that monitors such server capacity and statuses, and calculates a transfer frequency upper limit from the total capacity of the servers and sends the transfer frequency upper limit to the process determining unit 250, when the capacity or the status of the server changes.

When a server extension, expansion, enlargement, or addition is started, the SSMA communication unit 230 receives a server extension notification from the server-status monitoring apparatus 50, and predicts a timing at which the server extension is completed based on a predetermined time needed for the server extension. The SSMA communication unit 230 calculates the current transfer frequency upper limit and the transfer frequency upper limit upon completion of extension, and sends the timing predicted and the transfer frequency upper limit at the timing, together with the current transfer frequency upper limit to the process determining unit 250.

Upon receiving the server extension notification, the SSMA communication unit 230 sends the timing and the transfer frequency upper limit at that timing together with the current transfer frequency upper limit to the process determining unit 250, so that the process determining unit 250 can predict the stay time of the client request in consideration of an improvement on the server capacity that is brought about by the server extension.

The process determining unit 250, like the process determining unit 150, determines a process for a client request stored at the head of the request queue 110. Unlike the process determining unit 150, however, the process determining unit 250 determines whether to give a retransmission instruction or to make the client request stay on hold based on the predicted value of the stay time, not the actual stay time of the client request. When a server extension is started, the process determining unit 250 predicts the stay time of the client request in consideration of a probable improvement on the server capacity that will be made by the server extension.

The process determining unit 250 includes a new-request processing unit 251, a stay request processing unit 252, and a stay time predicting unit 253. When receiving a new client request, the new-request processing unit 251 determines whether to give a retransmission instruction or to make the client request stay on hold in the request queue 110 based on the predicted value of the stay time. The stay request processing unit 252 regularly determines a process for the stay client request.

The stay time predicting unit 253 predicts the stay time of the client request based on the transfer frequency upper limit. Specifically, the stay time predicting unit acquires Q/F, which is the number Q of client requests staying on hold measured by the stay request number measuring unit 220, divided by the transfer frequency upper limit F, as the predicted value of the stay time.

When the server extension is started, the stay time predicting unit 253 predicts the stay time of the client request in consideration of a probable improvement on the server capacity that will be made by the server extension. Specifically, when Q is greater than FT, the stay time predicting unit 253 takes a value obtained by T+(Q−FT)/F′ as the predicted value of the stay time. In this expression, T represents the required time for the server extension, and F′ represents the transfer frequency upper limit after the server extension.

Such prediction of the stay time of the client request by the stay time predicting unit 253 makes it possible to avoid determination to give a retransmission instruction based only on the current value of the server capacity with respect to a client request whose stay should be determined in consideration of the improved server capacity. This can further suppress wasteful retransmission requests.

Instead of the transfer frequency upper limit, the current request transfer frequency can be used in predicting the stay time. When the capacity of the server will fluctuate in future due to other causes than the server extension, the stay time can be predicted based on the result of the prediction of the server's capacity.

The data relay unit 260, like the data relay unit 160, relays data between the client terminal 10 or 20 and the server 30 or 40. Unlike the data relay unit 160, however, the data relay unit 260 notifies reception of a client request to the new-request processing unit 251 when receiving the client request from the client terminal 10 or 20. The data relay unit 260 performs a retransmission instruction process when the new-request processing unit 251 makes retransmission instruction determination based on the predicted value of the stay time, and adds the client request to the request queue 110 when the new-request processing unit 251 performs a stay determination.

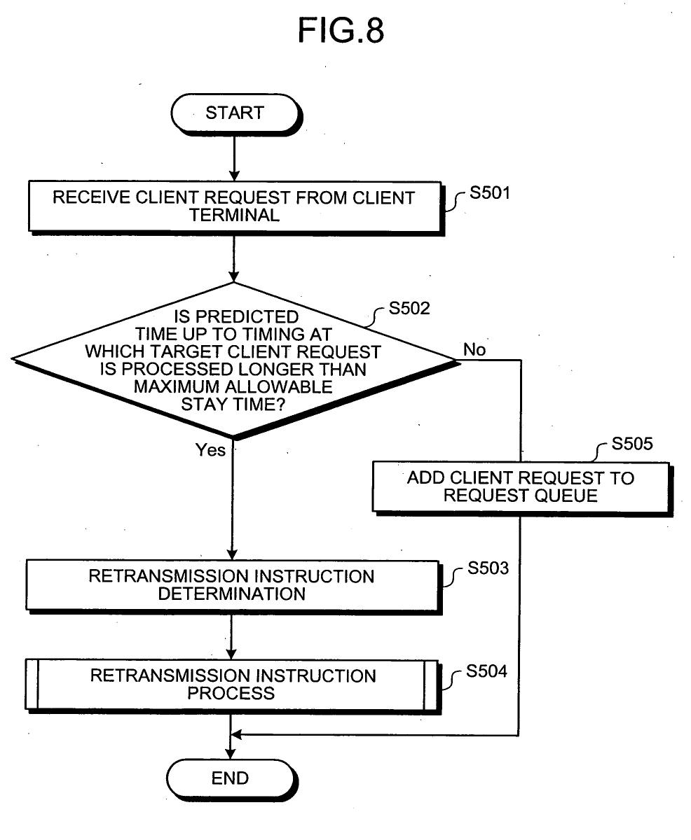

The following will explain procedures of the relay control apparatus 200 according to the second embodiment when receiving a new request. FIG. 8 is a flowchart of procedures of the relay control apparatus 200 according to the second embodiment that are performed when receiving a new request.

As shown in FIG. 8, when the data relay unit 260 in the relay control apparatus 200 receives a client request from the client terminal 10 or 20 (step S501), the stay time predicting unit 253 predicts a time up to a timing at which the client request is processed, and the new-request processing unit 251 determines whether the predicted time is longer than the maximum allowable stay time (step S502).

When the predicted time is longer than the maximum allowable stay time, the new-request processing unit 251 performs a retransmission instruction determination (step S503), and the data relay unit 260 performs a retransmission instruction process based on the determination made by the new-request processing unit 251 (step S504).

When the stay time is equal to or less than the maximum allowable stay time, the new-request processing unit 251 performs a stay determination, and the data relay unit 260 adds the client request to the request queue 110 based on the determination made by the new-request processing unit 251 (step S505).

As the stay time predicting unit 253 predicts the time up to the timing at which the client request is processed, and the new-request processing unit 251 performs a retransmission instruction determination or a stay determination based on the predicted time, a retransmission instruction can be given to the client terminal at an earlier timing.

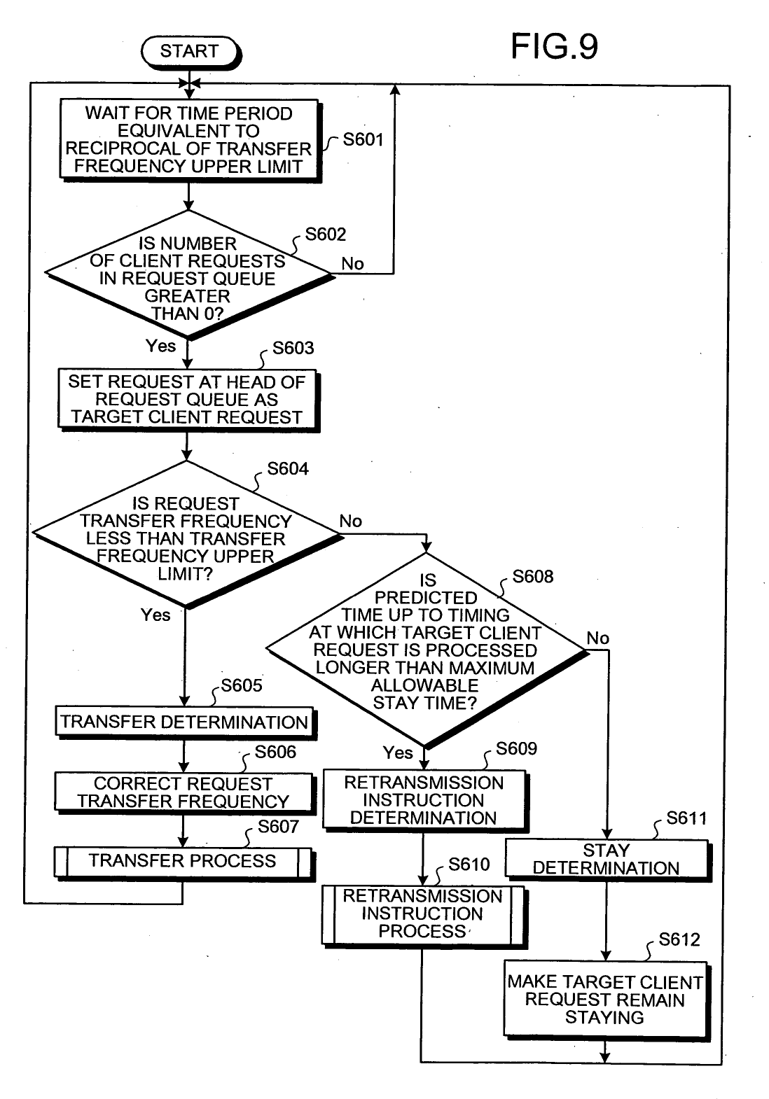

A stay request process carried out by the relay control apparatus 200 according to the second embodiment for processing a client request in the request queue 110 is now explained. FIG. 9 is a flowchart of procedures of a stay request process that is performed by the relay control apparatus 200 according to the second embodiment.

As shown in FIG. 9, in the stay request process, the processes at steps S201 to S207 in the stay request process in FIG. 4 correspond to the processes at steps S601 to S607, and the processes at steps S209 to S212 in FIG. 4 correspond to the processes at steps S609 to S612.

Unlike the relay control apparatus 100 according to the first embodiment that performs a retransmission instruction determination or a stay determination based on the stay time of a target client request at step S208, the relay control apparatus 200 according to the second embodiment performs a retransmission instruction determination or a stay determination based on a predicted time up to a timing at which a target client request is processed at step S608. The process performed by the process determining unit 150 in the stay request process shown in FIG. 4 is executed by the stay request processing unit 252 of the process determining unit 250 in the stay request process in FIG. 9.

According to the second embodiment, as described above, the process determining unit 250 performs a retransmission instruction determination or a stay determination based on the predicted value of the stay time of a client request, thereby suppressing a wasteful retransmission request to a client terminal and undesired occurrence of an unpleasant waiting time for a user. Furthermore, a retransmission instruction can be given at an earlier.

According to the second embodiment, when the server extension is started, the stay time predicting unit 253 in the process determining unit 250 predicts the stay time of the client request in consideration of a required time for the server extension and the server capacity that will be made by the server extension. This makes it possible to prevent an erroneous retransmission instruction based on the server capacity before the server extension in response to the client request that is made processable within the allowable time by the server extension.

While the foregoing descriptions of the first and the second embodiments have been given of the relay control apparatus, a relay control program having similar capabilities can be acquired by achieving the configuration of the relay control apparatus by software. The following will explain a computer that executes the relay control program.

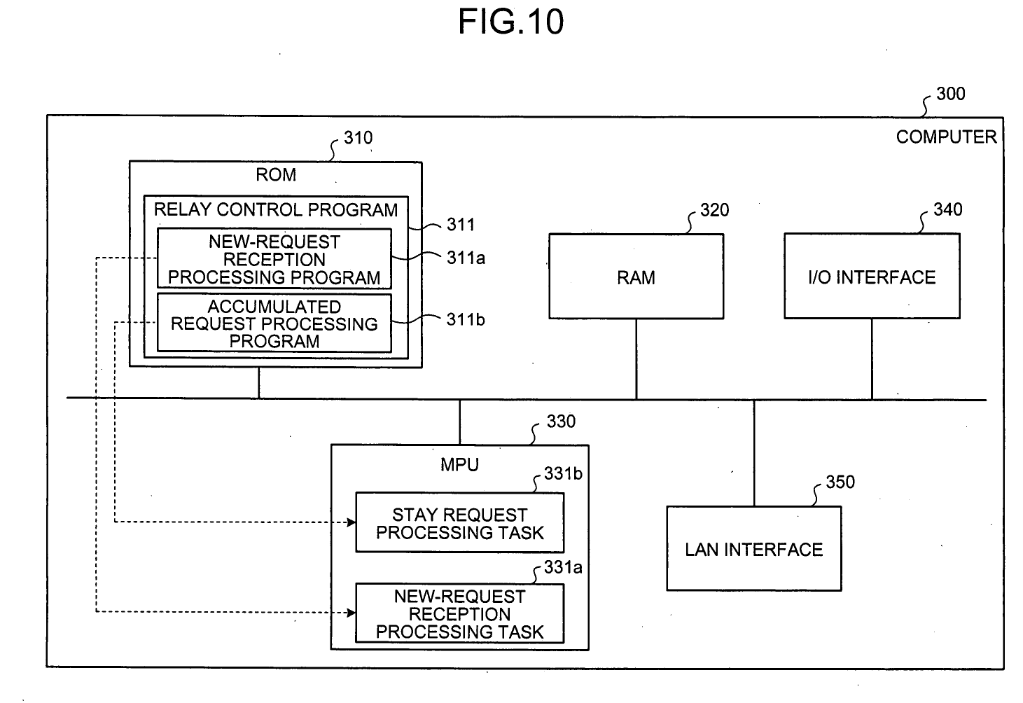

FIG. 10 is a functional block diagram of the configuration of a computer 300 that executes a relay control program according to the first and the second embodiments. As shown in FIG. 10, the computer 300 includes a read only memory (ROM) 310, a random access memory (RAM) 320, a micro processing unit (MPU) 330, an I/O interface 340, and a local area network (LAN) interface 350.

The ROM 310 is a read only memory that stores a relay control program 311 and constants and the like. The RAM 320 is a memory that stores intermediate results of executing the relay control program 311. The relay control program 311 includes a new-request reception processing program 311a that processes a new client request received from a client terminal, and a stay request processing program 311b that regularly processes a client request stored in the request queue.

The MPU 330 is a processing unit that reads the relay control program 311 from the ROM 310 and executes the program. The MPU 330 executes the new-request reception processing program 311a as a new-request reception task 331a, and executes the stay request processing program 311b as a stay request processing task 331b.

The I/O interface 340 connects input devices, such as a mouse and a keyboard, and a display device. The LAN interface 350 connects the computer 300 to a LAN.

While the foregoing descriptions of the first and the second embodiments have been given of the case of using a plurality of servers, the present invention is not limited to thereto. The invention can also be adapted when a single server is used.

While the foregoing descriptions of the first and the second embodiments have been given of the server-status monitoring apparatus 50 and the sorry server 60 are provided outside the relay control apparatus, the present invention is not limited to this particular case. The invention can also be adapted when the relay control apparatus has the capabilities of at least one of the server-status monitoring apparatus 50 and the sorry server 60.

While the foregoing descriptions of the first and the second embodiments have been given of the case of using the server-status monitoring apparatus 50, the present invention is not limited to this particular case. The invention can also be adapted to a case that a fixed value is used for the capacity of the server without using the server-status monitoring apparatus 50. The capacity of the server can be predicted from the request transfer frequency.

While the foregoing descriptions of the first and the second embodiments have been given of the case that all the client requests are processed with the same level of priority, the present invention is not limited thereto. The invention can also be adapted when client requests are separated according to different levels of priority, and a process determination is made for each priority level.

While the foregoing descriptions of the first and the second embodiments have been given of the case of using a relay control apparatus, the present invention is not limited to this particular case. The invention can also be adapted when at least one of the servers and client terminals have the capabilities of the relay control apparatus.

According to the present invention, as the allowable waiting time and the capacity of the server considered in the relay process, undesired generation of an unpleasant waiting time can be suppressed.

According to the present invention, as the instruction to retransmit the client request and the staying of the request are adequately executed when the system resources are insufficient, it is possible to suppress a wasteful retransmission request to a client terminal and undesired occurrence of an unpleasant waiting time.

According to the present invention, as an instruction to retransmit a client request and staying of a request are adequately executed when system resources are insufficient, it is possible to suppress a wasteful retransmission request to a client terminal and undesired occurrence of an unpleasant waiting time.

According to the present invention, as an instruction to retransmit a client request and staying of a request are adequately executed even when the capacity of a server changes, it is possible to suppress a wasteful retransmission request to a client terminal and undesired occurrence of an unpleasant waiting time.

According to the present invention, as the capacity of the server is evaluated adequately, overloading the server can be prevented.

According to the present invention, as the best use of the capacity of a server is made, a client request can be adequately relayed.

According to the present invention, erroneous retransmission instruction based on the server capacity before the server extension, in response to a client request that can be processed within an allowable time by the server extension can be prevented. Therefore a wasteful retransmission request to a client terminal can be suppressed.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable medium storing a computer program for controlling relay of a client request from a client terminal to a server, the computer program including instructions for causing a computer to execute:
determining a process corresponding to the client request, based on both an allowable waiting time for which the client terminal allows to wait for a response corresponding to the client request from the server and on a capacity of the server; and
processing the client request, based on a result of the determination.

2. The computer-readable medium according to claim 1, wherein
the determining includes:
determining whether transfer of the client request to the server is possible, based on the capacity of the server;
determining whether a maximum allowable stay time being a maximum time for which staying of the client request is allowed has elapsed, based on the allowable waiting time, when it is determined that the transfer is not possible;
determining to make the client terminal retransmit the client request, when it is determined that the allowable stay time has elapsed; and
determining to make the client request stay until the transfer to the server becomes possible, when it is determined that the maximum allowable stay time has not elapsed, and
the processing includes:
transferring the client request to the server, when it is determined that the transfer is possible;
instructing the client terminal to retransmit the client request, when it is determined to make the client terminal retransmit the client request; and
making the client request stay, when it is determined to make the client request stay.

3. The computer-readable medium according to claim 1, wherein
the determining includes:
determining whether transfer of the client request to the server is possible, based on the capacity of the server;
predicting whether a response to the client request is possible within a maximum allowable stay time being a maximum time for which the client request is allowed to stay, based on the allowable waiting time, when it is determined that the transfer is not possible;
determining to make the client terminal retransmit the client request, when it is predicted that the response is not possible; and determining to make the client request stay until the transfer to the server becomes possible, when it is predicted that the response is possible, and
the processing includes:
transferring the client request to the server, when it is determined that the transfer is possible;
instructing the client terminal to retransmit the client request, when it is determined to make the client terminal retransmit the client request; and
making the client request stay, when it is determined to make the client request stay.

4. The computer-readable medium according to claim 2, wherein
the computer is further caused to execute monitoring an operating status of the server to determine the capacity of the server, and
the determining whether the transfer of the client request to the server is possible includes determining whether the transfer of the client request to the server is possible, based on the capacity determined.

5. The computer-readable medium according to claim 3, wherein
the computer is further caused to execute monitoring an operating status of the server to determine the capacity of the server, and
the determining whether the transfer of the client request to the server is possible includes determining whether the transfer of the client request to the server is possible, based on the capacity determined.

6. The computer-readable medium according to claim 4, wherein the capacity determined is a transfer frequency upper limit being a maximum number of client requests that the server is capable of processing per time unit.

7. The computer-readable medium according to claim 5, wherein the capacity determined is a transfer frequency upper limit being a maximum number of client requests that the server is capable of processing per time unit.

8. The computer-readable medium according to claim 6, wherein the determining the process corresponding to the client request is executed every most frequent transfer period being is a reciprocal of the transfer frequency upper limit.

9. The computer-readable medium according to claim 7, wherein the determining the process corresponding to the client request is executed every most frequent transfer period being is a reciprocal of the transfer frequency upper limit.

10. The computer-readable medium according to claim 3, wherein the computer is further caused to execute:
monitoring an operating status of the server;
determining a first capacity of the server; and
determining a second capacity of the server after a server extension, when the server is extended, wherein
the predicting includes predicting whether the response to the client terminal within the maximum allowable stay time is possible, based on the first capacity and the second capacity.

11. The computer-readable medium according to claim 10, wherein the determining the first and second capacities include:
determining a timing at which the first capacity changes to the second capacity, based on a time required for the server extension; and
predicting whether the response to the client terminal within the maximum allowable stay time is possible, based on the timing determined.

12. The computer-readable medium according to claim 3, wherein the computer is further caused to execute:
predicting whether the response to the client terminal within the maximum allowable stay time is possible, when the client request is received from the client terminal; and
instructing the client terminal to retransmit the client request, when it is predicted that the response is not possible.

13. A relay control method for controlling relay of a client request from a client terminal to a server, comprising:
determining a process corresponding to the client request, based on both an allowable waiting time for which the client terminal allows to wait for a response corresponding to the client request from the server and on a capacity of the server; and
processing the client request, based on a result of the determination.

14. The relay control method according to claim 13, wherein
the determining includes:
determining whether transfer of the client request to the server is possible, based on the capacity of the server;
determining whether a maximum allowable stay time being a maximum time for which staying of the client request is allowed has elapsed, based on the allowable waiting time, when it is determined that the transfer is not possible;
determining to make the client terminal retransmit the client request, when it is determined that the allowable stay time has elapsed; and
determining to make the client request stay until the transfer to the server becomes possible, when it is determined that the maximum allowable stay time has not elapsed, and
the processing includes:
transferring the client request to the server, when it is determined that the transfer is possible;
instructing the client terminal to retransmit the client request, when it is determined to make the client terminal retransmit the client request; and
making the client request stay, when it is determined to make the client request stay.

15. The relay control method according to claim 13, wherein
the determining includes:
determining whether transfer of the client request to the server is possible, based on the capacity of the server;
predicting whether a response to the client request is possible within a maximum allowable stay time being a maximum time for which the client request is allowed to stay, based on the allowable waiting time, when it is determined that the transfer is not possible;
determining to make the client terminal retransmit the client request, when it is predicted that the response is not possible; and determining to make the client request stay until the transfer to the server becomes possible, when it is predicted that the response is possible, and
the processing includes:
transferring the client request to the server, when it is determined that the transfer is possible;
instructing the client terminal to retransmit the client request, when it is determined to make the client terminal retransmit the client request; and
making the client request stay, when it is determined to make the client request stay.

16. A relay control apparatus for controlling relay of a client request from a client terminal to a server, comprising:
a process determining unit configured to determine a process corresponding to the client request, based on both an allowable waiting time for which the client terminal allows to wait for a response corresponding to the client request from the server and on a capacity of the server; and
a request processing unit configured to process the client request, based on the determination made by the process determining unit.

17. The relay control apparatus according to claim 16, wherein
the process determining unit includes:
a transfer determining unit configured to determine whether transfer of the client request to the server is possible, based on the capacity of the server;
a stay control unit configured to
determine whether a maximum allowable stay time being a maximum time for which staying of the client request is allowed has elapsed, based on the allowable waiting time, when the transfer determining unit determines that the transfer is not possible,
determine to make the client terminal retransmit the client request, when it is determined that the allowable stay time has elapsed, and
determine to make the client request stay until the transfer to the server becomes possible, when it is determined that the maximum allowable stay time has not elapsed, and
the request processing unit is configured to
transfer the client request to the server, when the transfer determining unit determines that the transfer is possible,
instruct the client terminal to retransmit the client request, when the stay control unit determines to make the client terminal retransmit the client request, and
make the client request stay, when the stay control unit determines to make the client request stay.

18. The relay control apparatus according to claim 16, wherein
the process determining unit includes:
a transfer determining unit configured to determine whether transfer of the client request to the server is possible, based on the capacity of the server; and
a stay control unit configured to
predict whether a response to the client request is possible within a maximum allowable stay time being a maximum time for which the client request is allowed to stay, based on the allowable waiting time, when the transfer determining unit determines that the transfer is not possible,
determine to make the client terminal retransmit the client request, when it is predicted that the response is not possible, and determine to make the client request stay until the transfer to the server becomes possible, when it is predicted that the response is possible, and
the request processing unit is configured to
transfer the client request to the server, when the transfer determining unit determines that the transfer is possible,
instruct the client terminal to retransmit the client request, when the stay control unit determines to make the client terminal retransmit the client request, and
make the client request stay, when the stay control unit determines to make the client request stay.
